(19) United States
(12) Patent Application Publication
(10) Pub. No.: US 2017/0351384 A1
(43) Pub. Date: Dec. 7, 2017

(54) TOUCH DISPLAY SYSTEM AND CORRECITON METHOD THEREOF

(71) Applicant: Coretronic Corporation, Hsin-Chu (TW)

(72) Inventors: Nan-Jiun Yin, Hsin-Chu (TW); Pen-Ning Kuo, Hsin-Chu (TW)

(73) Assignee: Coretronic Corporation, Hsin-Chu (TW)

(21) Appl. No.: 15/610,625

(22) Filed: Jun. 1, 2017

(30) Foreign Application Priority Data
Jun. 2, 2016 (CN) 201610382363.5

(51) Int. Cl. G06F 3/042; G06F 3/041

(52) U.S. Cl. CPC G06F 3/0425; G06F 3/0418

(57) ABSTRACT

A touch display system and a correction method thereof are provided. A correction image is displayed on a touch display surface of the touch display system, where the touch display surface has an electrode circuit layer and an alignment arrangement disposed thereon, the alignment arrangement has a plurality of mark patterns used for forming alignment regions, the electrode circuit layer has electrode sensing regions, and each of the alignment regions and each of the electrode sensing regions have a predetermined proportion relationship there between. A position corresponding relationship between the correction image and each of the alignment regions on the touch display surface is corrected according to the capturing image including the correction image and the mark patterns. The touch display system and the correction method thereof may effectively save a time required for correcting touch points and improve correction accuracy of the touch points.

### CROSS-REFERENCE TO RELATED APPLICATION

This application claims the priority benefit of China application serial no. 201610382363.5, filed on Jun. 2, 2016. The entirety of the above-mentioned patent application is hereby incorporated by reference herein and made a part of this specification.

### BACKGROUND OF THE INVENTION

### Field of the Invention

The invention relates to a display system, and particularly relates to a touch display system and a correction method thereof.

### Description of Related Art

Along with development of electronic science and technology, electronic devices are often used to execute a plurality of tasks in people's daily life, and to use a touch screen as a man-machine operation interface has become the most commonly used method.

In a large-size touch display system, it often needs to correct a display region provided by a display device and a touch region provided by a touch device, such that a frame displayed by the display device may correctly reflect a touch operation received by the touch device, so as to facilitate smooth interaction between a user and the touch display system. However, as a display frame of the touch display device becomes more and more large, an existing correction method takes too much time, and correction accuracy thereof cannot satisfy user's demand.

The information disclosed in this Background section is only for enhancement of understanding of the background of the described technology and therefore it may contain information that does not form the prior art that is already known to a person of ordinary skill in the art. Further, the information disclosed in the Background section does not mean that one or more problems to be resolved by one or more embodiments of the invention was acknowledged by a person of ordinary skill in the art.

### SUMMARY OF THE INVENTION

The invention is directed to a touch display system and a correction method thereof, by which a correction time of touch points is effectively saved, and correction accuracy of the touch points is improved.

Other objects and advantages of the invention can be further illustrated by the technical features broadly embodied and described as follows.

In order to achieve one or a portion of or all of the objects or other objects, an embodiment of the invention provides a touch display system including a touch display device, an image capturing device and a processing device. The touch display device has a touch display surface, and the touch display surface is configured to display a correction image. The touch display surface has an electrode circuit layer and an alignment arrangement disposed on the electrode circuit layer, where the alignment arrangement has a plurality of mark patterns used for forming a plurality of alignment regions. The electrode circuit layer has a plurality of electrode sensing regions, and each of the alignment regions and each of the electrode sensing regions have a predetermined proportion relationship there between. The image capturing device captures the correction image and the mark patterns to generate a capturing image. The processing device is coupled to the touch display device and the image capturing device, and corrects a position corresponding relationship between the correction image and each of the alignment regions on the touch display surface according to the capturing image.

In embodiment of the invention provides a correction method of a touch display system, which includes following steps. A correction image is displayed on a touch display surface of the touch display system, where the touch display surface has an electrode circuit layer and an alignment arrangement disposed on the electrode circuit layer, where the alignment arrangement has a plurality of mark patterns used for forming a plurality of alignment regions, the electrode circuit layer has a plurality of electrode sensing regions, and each of the alignment regions and each of the electrode sensing regions have a predetermined proportion relationship there between. The correction image and the mark patterns are captured to generate a capturing image. A position corresponding relationship between the correction image and each of the alignment regions on the touch display surface is corrected according to the capturing image.

According to the above descriptions, in the embodiments of the invention, the correction image is displayed on the touch display surface of the touch display system, where the touch display surface has the electrode circuit layer and the alignment arrangement disposed on the electrode circuit layer, the alignment arrangement has a plurality of mark patterns used for forming a plurality of alignment regions. The electrode circuit layer has a plurality of electrode sensing regions, and each of the alignment regions and each of the electrode sensing regions have the predetermined proportion relationship there between. By correcting the position corresponding relationship between the correction image and each of the alignment regions on the touch display surface according to the capturing image including the correction image and the mark patterns, a time required for correcting touch points is effectively saved, and correction accuracy of the touch points is improved.

Other objectives, features and advantages of the present invention will be further understood from the further technological features disclosed by the embodiments of the present invention wherein there are shown and described preferred embodiments of this invention, simply by way of illustration of modes best suited to carry out the invention.

In order to make the aforementioned and other features and advantages of the invention comprehensible, several exemplary embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram of a touch display system according to an embodiment of the invention.

FIG. 2 is a partial schematic diagram of a touch display device according to an embodiment of the invention.

FIG. 3 is a schematic diagram of an alignment arrangement and a correction image on a touch display surface according to an embodiment of the invention.

FIG. 4 is a schematic diagram of mark patterns and a correction image on a touch display surface according to an embodiment of the invention.

FIG. 5 is a schematic diagram of mark patterns and a correction image on a touch display surface according to an embodiment of the invention.

FIG. 6 is a schematic diagram of a touch display system according to another embodiment of the invention.

FIG. 7A is a schematic diagram of a touch display system according to still another embodiment of the invention.

FIG. 7B is a partial schematic diagram of a touch display device according to another embodiment of the invention.

FIG. 8 is a flowchart illustrating a correction method of a touch display system according to an embodiment of the invention.

FIG. 9 is a flowchart illustrating a correction method of a touch display system according to another embodiment of the invention.

### DESCRIPTION OF EMBODIMENTS

It is to be understood that other embodiment may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings.

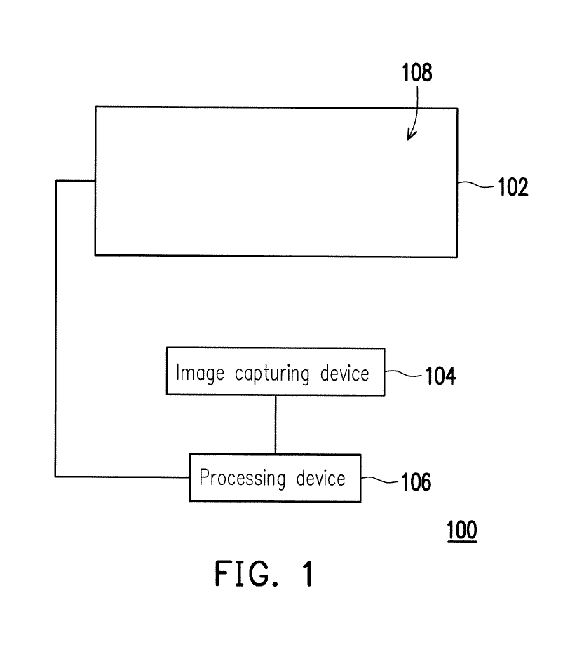

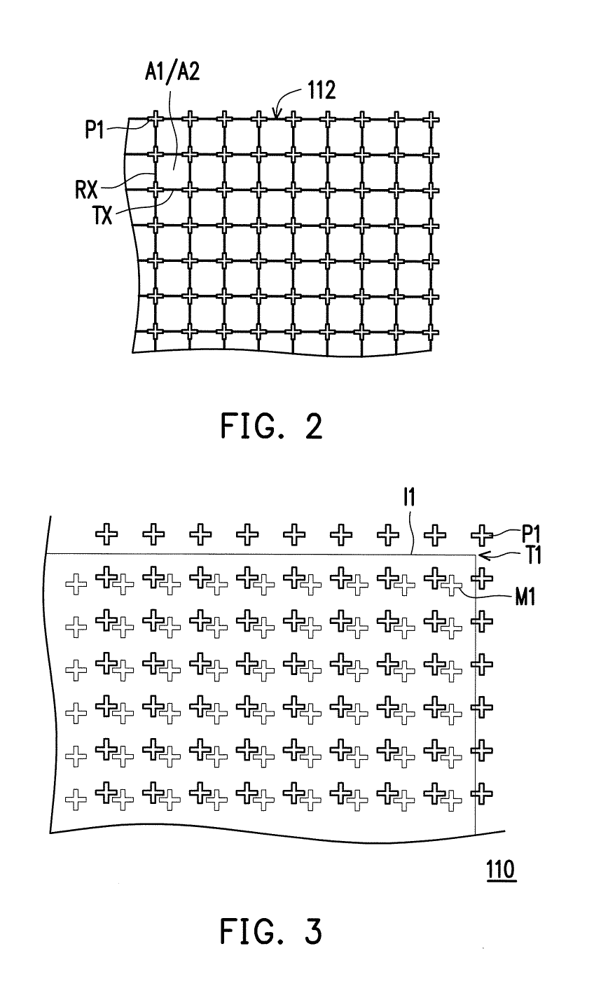

FIG. 1 is a schematic diagram of a touch display system according to an embodiment of the invention. Referring to FIG. 1, the touch display system 100 includes a touch display device 102, an image capturing device 104 and a processing device 106, where the processing device 106 is coupled to the touch display device 102 and the image capturing device 104. The touch display device 102 has a touch display surface 108, and the touch display surface 108 is configured to display a correction image, and the touch display surface 108 has an electrode circuit layer and an alignment arrangement disposed on the electrode circuit layer. Further, referring to FIG. 2, FIG. 2 is a partial schematic diagram of a touch display device according to an embodiment of the invention. The touch display device 102 may include an electrode circuit layer 112 having a plurality of transmitting electrode circuits TX and a plurality of receiving electrode circuits RX, and the alignment arrangement includes a plurality of cross-shape mark patterns P1, which are respectively located at intersections of the transmitting electrode circuits TX and the receiving electrode circuits RX to coincide with the transmitting electrode circuits TX and the receiving electrode circuits RX. The transmitting electrode circuits TX and the receiving electrode circuits RX are, for example, made of gold, silver, copper, nano carbon tube, indium tin oxide, or other proper conductive materials, though the invention is not limited thereto.

In the embodiment, every four mark patterns P1 encircles an alignment region A1, and the transmitting electrode circuits TX and the receiving electrode circuits RX form a plurality of electrode sensing regions A2. An area of each of the alignment regions A1 and an area of each of the electrode sensing regions A2 have a predetermined proportion relationship there between. In the present embodiment, the predetermined proportion relationship is 1:1, though the invention is not limited thereto. In some embodiments, the predetermined proportion relationship can also be 1:1.5, 1:2, 1:2.5, 1:3 or other proper proportion relationships. Moreover, shapes of the aforementioned mark patterns P1 can also be other shapes, for example, circles, triangles, rhombuses, rectangles, or other proper shapes. Shapes of the alignment regions A1 and the electrode sensing regions A2 are not limited to rectangles, but can also be parallelograms, rhombuses, triangles, or other proper shapes. The alignment regions A1 and the electrode sensing regions A2 are unnecessary to be completely coincided or have a same size. A distance between each two of the mark patterns P1 can be changed according to an actual application requirement, for example, the distance between the mark patterns P1 can be enlarged to save a usage amount of a material used for manufacturing the mark patterns P1. Namely, as long as a relative position relationship between the alignment regions A1 and the electrode sensing regions A2 is fixed, it can be used for implementing the alignment arrangement and the electrode circuit layer of the embodiment.

Moreover, the image capturing device 104 of the embodiment is, for example, a charge-coupled device (CCD), a complementary metal-oxide-semiconductor (CMOS) or other suitable electronic device. The processing device 106 is, for example, a personal computer (PC), a notebook computer, a tablet PC, a smart phone, a server, a chipset integrated into the touch display device 102 or other suitable electronic device, a single core or multi-core central processing unit (CPU), etc., which is not limited by the invention.

FIG. 3 is a schematic diagram of an alignment arrangement and a correction image in a capturing image according to an embodiment of the invention. Referring to FIG. 1 to FIG. 3, the correction image I1 may include a plurality of correction patterns M1, and in the embodiment, each correction pattern M1, for example, has a cross shape, though the invention is not limited thereto, and each correction pattern M1 can also be a circle, triangle, a rhombus, a rectangle, a ring, a star or other proper shapes. The image capturing device 104 captures an image of the touch display surface 108 to generate a capturing image 110. The content of the capturing image 110, for example, includes the plurality of correction patterns M1 and the plurality of mark patterns P1, and the processing device 106 may correct a position corresponding relationship between the correction patterns M1 in the correction image I1 and each of the alignment regions A1 on the touch display surface 108 according to the capturing image 110. Further, the processing device 106 may correct a position corresponding relationship between a vertex T1 of the correction image I1 and the corresponding one of the alignment regions A1 according to the capturing image 110, or correct the position corresponding relationship between each of the correction patterns M1 and the corresponding one of the alignment regions A1 according to a coordinate position of each of the correction patterns M1 of the capturing image 110 in the corresponding alignment region A1.

In this way, by correcting the position corresponding relationship between the correction image I1 and each of the alignment regions A1 on the touch display surface 108 according to the capturing image 110 generated by capturing the correction image I1 and the mark patterns P1, a time required for correcting touch points is effectively saved, and correction accuracy of the touch points is improved, where the higher a distribution density of the correction patterns M1 and the mark patterns P1 is, the higher the correction accuracy is.

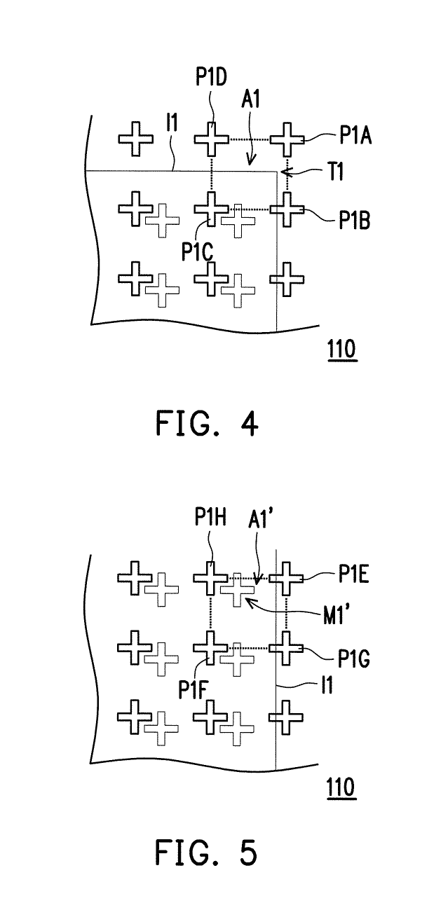

For example, FIG. 4 is a schematic diagram of mark patterns and a correction image according to an embodiment of the invention. Referring to FIG. 4, in the embodiment, a position of the vertex T1 of the correction image I1 can be corrected according to the alignment region A1 formed by the mark patterns P1A, P1B, P1C, P1D. For example, coordinates of the mark patterns P1A, P1B, P1C and P1D are respectively (0,0), (0,10), (10,10), and (10,0), such that the alignment region A1 is divided into 10×10 coordinate points, and the processing device 106 obtains corresponding coordinate (1,4) of the vertex T1 in the alignment region A1 according to the capturing image 110. In this way, in the alignment region A1 formed by the mark patterns P1A, P1B, P1C and P1D, the processing device 106 may take the coordinate of the vertex T1 as a reference to obtain corresponding coordinates of positions of the correction image I1 on the alignment region A1, so as to effectively correct the position corresponding relationship between each position of the correction image I1 and each of the alignment regions A1.

FIG. 5 is a schematic diagram of mark patterns and a correction image according to an embodiment of the invention. Referring to FIG. 5, in the embodiment, a position of a correction pattern M1′ can be corrected according to alignment region A1′ formed by mark patterns P1E, P1F, P1G and P1H. For example, coordinates of the mark patterns P1E, P1F, P1G and P1H are respectively (0,20), (10,30), (0,30), and (10,20), such that the alignment region A1′ is divided into 10×10 coordinate points, and the processing device 106 obtains corresponding coordinate (7,21) of the correction pattern M1′ in the alignment region A1′ according to the capturing image 110. In this way, in the alignment region A1′ formed by the mark patterns P1E, P1F, P1G and P1H, the processing device 106 may take the coordinate of the correction pattern M1′ as a reference to obtain corresponding coordinate of each position of the correction image I1 on the alignment region A1′, so as to effectively correct the position corresponding relationship between each position of the correction image I1 and each of the alignment regions A1′.

It should be noted that the invention is not limited to implement alignment of the correction patterns M1 or M1′ of FIG. 4 and FIG. 5 in the alignment region A1 or A1′ according to the aforementioned implementations, and other existing algorithms of the technical field can also be adopted to calculate the coordinates of correction patterns M1 (or M1′) in the alignment region A1 (or A1′). Moreover, the mark patterns P1 of the aforementioned embodiment are, for example, invisible light patterns. Further, the invisible light patterns (for example, fabricated through infrared invisible ink or ultraviolet invisible ink, though the invention is not limited thereto) can be coated on the touch display surface 108 through a screen printing process.

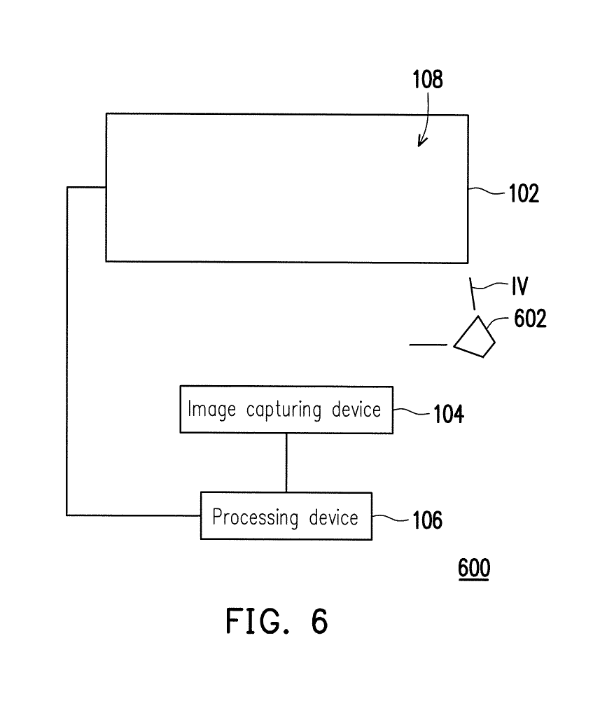

FIG. 6 is a schematic diagram of a touch display system according to another embodiment of the invention. Referring to FIG. 6, compared to the touch display system 100, the touch display system 600 of the embodiment is similar to the touch display system 100, and a main difference there between is that the touch display system 600 further includes an invisible light source 602. The invisible light source 602 may provide an invisible light IV corresponding to an ink material of the mark patterns P1. For example, in case that the mark patterns P1 are implemented by the infrared invisible ink, when the image capturing device 104 captures an image of the mark patterns P1, the invisible light source 602 capable of emitting an infrared light provides the infrared light to irradiate the touch display surface to emerge the mark patterns P1. Moreover, in case that the mark patterns P1 are implemented by the ultraviolet invisible ink, the invisible light source 602 capable of emitting an ultraviolet light provides the ultraviolet light to irradiate the touch display surface to emerge the mark patterns P1 and meanwhile sterilize the touch display surface 108, which is not limited by the invention. The image capturing device 104 may perform an image capturing operation when the touch display surface 108 displays the correction image I1 and the invisible light source 602 provides the invisible light to irradiate the touch display surface 108, so as to simultaneously capture the correction image I1 and the mark patterns P1. Then, the processing device 106 may correct the position corresponding relationship between the correction image I1 and each of the alignment regions A1 according to the captured capturing image.

Moreover, in some embodiments, the image capturing device 104 may respectively perform image capturing operation in tandem when the touch display surface 108 displays the correction image I1 and when the invisible light source 602 provides the invisible light to irradiate the touch display surface 108, and then the processing device 106 corrects the position corresponding relationship between the correction image I1 and each of the alignment regions A1 according to the two capturing images. Moreover, a color of the correction patterns M1 (or M1′) in the correction image I1 can be different to a color of the emerged mark patterns P1, so as to increase distinctiveness of the correction patterns M1 (or M1′) and the mark patterns P1, though the invention is not limited thereto.

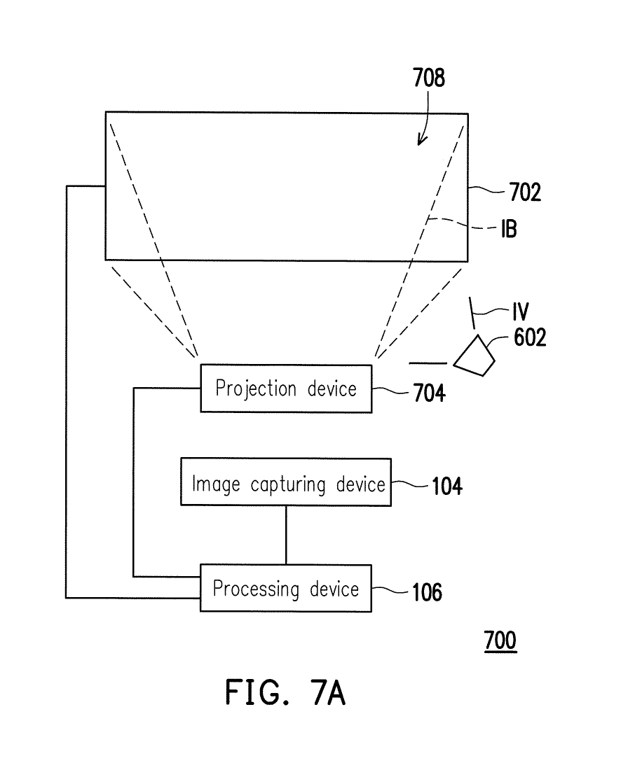

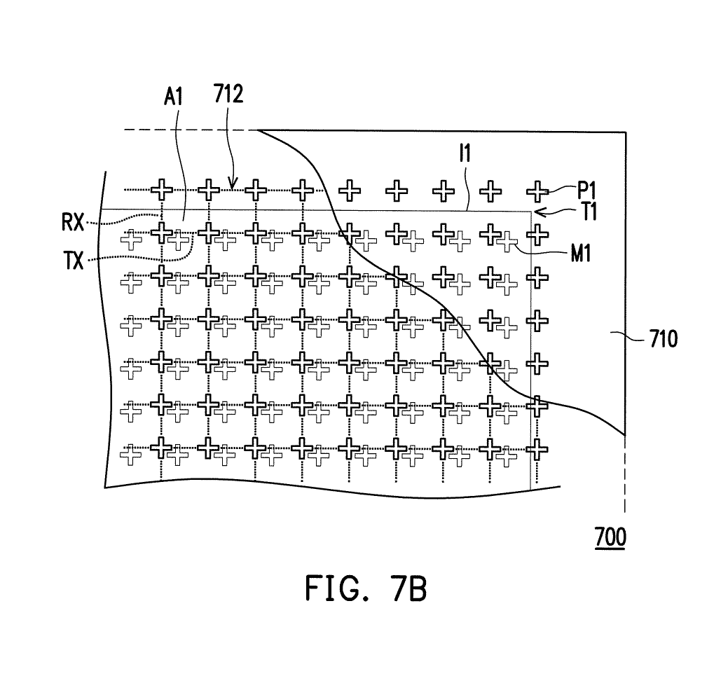

FIG. 7A is a schematic diagram of a touch display system according to still another embodiment of the invention, and FIG. 7B is a partial schematic diagram of a touch display device according to another embodiment of the invention. Referring to FIG. 7A, the touch display system 700 is similar to the touch display system 600 of FIG. 6, and a main difference there between is that the touch display device in the touch display system 700 includes a projection screen 702 and a projection device 704. The projection screen 702 and the projection device 704 are respectively coupled to the processing device 106. The projection screen 702 is, for example, a capacitive touch projection screen, an electromagnetic touch projection screen, a resistive touch projection screen or other proper touch projection screen, and the projection screen 702 is used for receiving an image beam IB projected by the projection device 704 to display the correction image I1 and implement a touch sensing operation.

Further, referring to FIG. 7A and FIG. 7B, the projection screen 702 may include reflection layer 710 and an electrode circuit layer 712, where the reflection layer 710 is disposed on the electrode circuit layer 712 (in FIG. 7B, only a part of the reflection layer 710 covering the electrode circuit layer 712 is schematically illustrated, and the reflection layer 710 may completely cover the electrode circuit layer 712), so as to receive the image beam IB and display the correction image I1, and the electrode circuit layer 712 is coupled to the processing device 106 for sensing a touch operation. A surface of the reflection layer 710 presents a white color, for example, a white coating such as TiO2, etc., is mixed into a transparent substrate (made of, for example, PET, epoxy resin or other proper material), or the white coating is directly coated on a transparent substrate (made of, for example, PET, glass or other proper material), though the invention is not limited thereto. Moreover, the mark patterns P1 of the alignment arrangement are for example, coated on the reflection layer 710 through a screen printing process. The reflection layer 710 and the mark patterns P1 of the alignment arrangement can be respectively fabricated through different fabrication processes. When the mark patterns P1 of the alignment arrangement are coated, by aligning the reflection layer 710 and alignment marks (not shown) on a screen printing fixture, the mark patterns P1 of the alignment arrangement can be coated on the reflection layer corresponding to positions of the intersections between the transmitting electrode circuits TX and the receiving electrode circuits RX on the electrode circuit layer 712. The mark patterns P1 of the alignment arrangement, the reflection layer 710 and the electrode circuit layer 712 can be simultaneously formed through a roll to roll process or other proper methods, which is not limited by the invention. When the image capturing device 104 captures an image of the mark patterns P1, the invisible light source 602 provides the invisible light IV to irradiate the touch display surface to emerge the mark patterns P1. The image capturing device 104 may simultaneously capture the correction image I1 and the mark patterns P1 or capture the same in tandem, and the processing device 106 may correct the position corresponding relationship between the correction image I1 and each of the alignment regions A1 according to the captured capturing image (similar to the capturing image 110 shown in FIG. 3 and FIG. 4). Since touch position correction can be independently performed to each of the alignment regions A1 when a projected image on the reflection layer 710 has an image skew problem due to unevenness of the projection screen 702 or due to a projection angle of the image beam IB of the projection device 704, the problem of inaccurate touch position correction caused by skew of the projected image can be greatly mitigated.

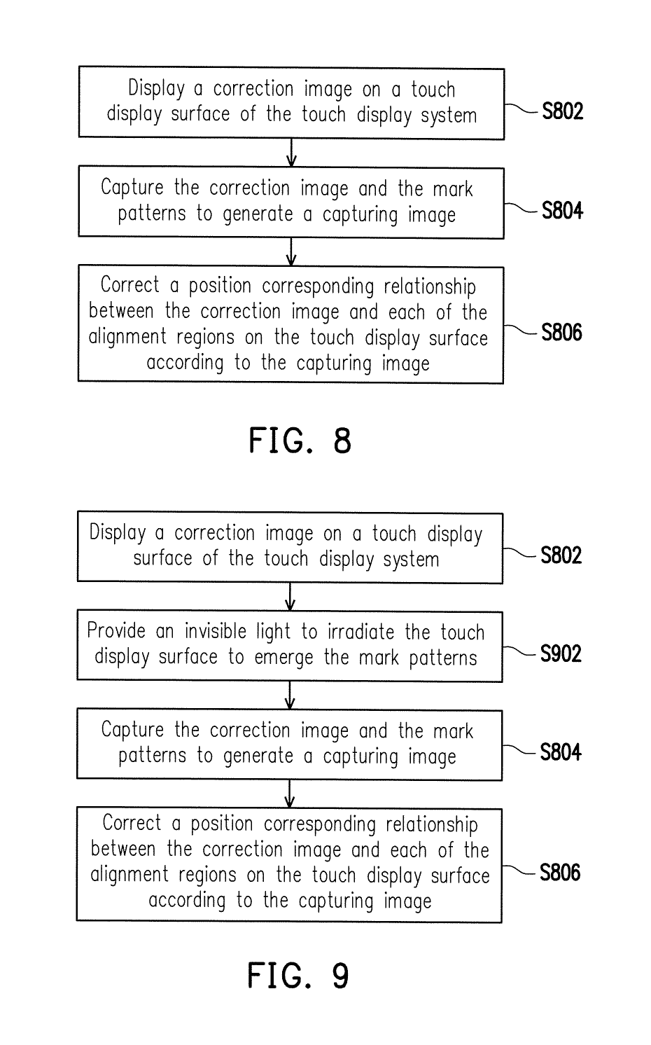

FIG. 8 is a flowchart illustrating a correction method of a touch display system according to an embodiment of the invention. Referring to FIG. 8, according to the aforementioned embodiments, it is known that the correction method of the touch display system may include following steps. First, a correction image is displayed on a touch display surface of the touch display system (step S802), where the touch display surface has an electrode circuit layer and an alignment arrangement disposed on the electrode circuit layer, the alignment arrangement has a plurality of mark patterns used for forming a plurality of alignment regions, the electrode circuit layer has a plurality of electrode sensing regions, and each of the alignment regions and each of the electrode sensing regions have a predetermined proportion relationship there between. The correction image is, for example, displayed by a touch display panel, or displayed by a projection screen by receiving an image beam projected by a projection device, where the projection screen is, for example, a capacitive touch projection screen, an electromagnetic touch projection screen, a resistive touch projection screen or other proper touch projection screen, and the projection screen can be used for sensing a touch operation. Further, the projection screen may include a reflection layer and an electrode circuit layer, where the reflection layer is disposed on the electrode circuit layer for receiving the image beam to display the correction image, and the electrode circuit layer is used for sensing the touch operation. Moreover, the mark patterns of the alignment arrangement are, for example, coated on the reflection layer through a screen printing process. Then, the correction image and the mark patterns are captured to generate a capturing image (step S804), where the correction image includes a plurality of correction patterns, and the correction image and the mark patterns can be simultaneously captured or captured in tandem. Thereafter, a position corresponding relationship between the correction image and each of the alignment regions on the touch display surface is corrected according to the capturing image (step S806), for example, the position corresponding relationship between the correction image or the correction patterns and each of the alignment regions is corrected according to a vertex of the correction image or a coordinate position of each of the correction patterns in the corresponding alignment region.

FIG. 9 is a flowchart illustrating a correction method of a touch display system according to another embodiment of the invention. Referring to FIG. 9, the correction method of the touch display system of the embodiment is similar to the correction method of FIG. 8, and a difference there between is that the mark patterns of the embodiment are invisible light patterns, so that a step S902 is further included between the step S802 and the step S804, i.e. an invisible light is provided to irradiate the touch display surface to emerge the mark patterns.

In summary, the correction image is displayed on the touch display surface of the touch display system, where the touch display surface has the electrode circuit layer and the alignment arrangement disposed on the electrode circuit layer, the alignment arrangement has a plurality of mark patterns used for forming a plurality of alignment regions. The electrode circuit layer has a plurality of electrode sensing regions, and each of the alignment regions and each of the electrode sensing regions have the predetermined proportion relationship there between. By correcting the position corresponding relationship between the correction image and each of the alignment regions on the touch display surface according to the capturing image including the correction image and the mark patterns, a time required for correcting touch points is effectively saved, and correction accuracy of the touch points is improved. Moreover, in case that the correction image is a projection image, the problem of inaccurate touch position correction caused by skew of the projected image can be greatly mitigated.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A touch display system, comprising:
a touch display device, having a touch display surface configured to display a correction image, the touch display surface having an electrode circuit layer and an alignment arrangement disposed on the electrode circuit layer, wherein the alignment arrangement has a plurality of mark patterns used for forming a plurality of alignment regions, the electrode circuit layer has a plurality of electrode sensing regions, and each of the alignment regions and each of the electrode sensing regions have a predetermined proportion relationship there between;
an image capturing device, capturing the correction image and the mark patterns to generate a capturing image; and
a processing device, coupled to the touch display device and the image capturing device, and correcting a position corresponding relationship between the correction image and each of the alignment regions on the touch display surface according to the capturing image.

2. The touch display system as claimed in claim 1, wherein the mark patterns are invisible light patterns, and the touch display system further comprises:
an invisible light source, providing an invisible light to irradiate the touch display surface to emerge the mark patterns, wherein the image capturing device captures the mark patterns.

3. The touch display system as claimed in claim 2, wherein the touch display device comprises:
a projection device, coupled to the processing device; and
a projection screen, coupled to the processing device, and having the alignment arrangement and the electrode circuit layer, wherein the projection screen receives an image beam projected by the projection device to display the correction image.

4. The touch display system as claimed in claim 3, wherein the projection screen further comprises:
a reflection layer, disposed on the electrode circuit layer, and the alignment arrangement being formed on the reflection layer, wherein the reflection layer receives the image beam to display the correction image.

5. The touch display system as claimed in claim 2, wherein the touch display device is a touch display panel.

6. The touch display system as claimed in claim 2, wherein the image capturing device simultaneously captures the correction image and the mark patterns.

7. The touch display system as claimed in claim 1, wherein the correction image comprises a plurality of correction patterns, and the processing device further corrects the position corresponding relationship between the correction image or the correction patterns and each of the alignment regions according to a vertex of the correction image in the capturing image or a coordinate position of each of the correction patterns in the corresponding alignment region.

8. A correction method of a touch display system, comprising:
displaying a correction image on a touch display surface of the touch display system, wherein the touch display surface has an electrode circuit layer and an alignment arrangement disposed on the electrode circuit layer, the alignment arrangement has a plurality of mark patterns used for forming a plurality of alignment regions, the electrode circuit layer has a plurality of electrode sensing regions, and each of the alignment regions and each of the electrode sensing regions have a predetermined proportion relationship there between;
capturing the correction image and the mark patterns to generate a capturing image; and
correcting a position corresponding relationship between the correction image and each of the alignment regions on the touch display surface according to the capturing image.

9. The correction method of the touch display system as claimed in claim 8, wherein the mark patterns are invisible light patterns, and the correction method of the touch display system further comprises:
providing an invisible light to irradiate the touch display surface to emerge the mark patterns.

10. The correction method of the touch display system as claimed in claim 8, wherein the touch display device comprises a projection device and a projection screen, the projection screen has the alignment arrangement and the electrode circuit layer, and the projection screen receives an image beam projected by the projection device to display the correction image.

11. The correction method of the touch display system as claimed in claim 10, wherein the projection screen further comprises:
a reflection layer, disposed on the electrode circuit layer, and the alignment arrangement being formed on the reflection layer, wherein the reflection layer receives the image beam to display the correction image.

12. The correction method of the touch display system as claimed in claim 9, wherein the correction image is displayed by a touch display panel.

13. The correction method of the touch display system as claimed in claim 9, further comprising:
simultaneously capturing the correction image and the mark patterns.

14. The correction method of the touch display system as claimed in claim 9, wherein the correction image comprises a plurality of correction patterns, and the correction method of the touch display system comprises:
correcting the position corresponding relationship between the correction image or the correction patterns and each of the alignment regions according to a vertex of the correction image or a coordinate position of each of the correction patterns in the corresponding alignment region.
